(19) United States
(12) Patent Application Publication
(10) Pub. No.: US 2026/0017247 A1
(43) Pub. Date: Jan. 15, 2026

(54) METHODS AND APPARATUS FOR COMPRESSION MODES IN HARDWARE ACCELERATORS

(71) Applicant: Intel Corporation, Santa Clara, CA (US)

(72) Inventors: James David Guilford, Northborough, MA (US); Daniel Frederick Cutter, Maynard, MA (US); Vinodh Gopal, Westborough, MA (US)

(73) Assignee: Intel Corporation, Santa Clara, CA (US)

(21) Appl. No.: 19/331,827

(22) Filed: Sep. 17, 2025

(51) Int. Cl. G06F 16/23; G06F 9/50

(52) U.S. Cl. CPC G06F 16/2365; G06F 9/5044; G06F 9/505

(57) ABSTRACT

This disclosure relates generally to hardware accelerators and, more particularly, to methods and apparatus for compression modes in hardware accelerators. An example apparatus includes machine readable instructions, and programmable circuitry to at least one of instantiate or execute the machine readable instructions to determine if an indication of compression mode selection corresponding to first data is present, if the indication is not present, select a compression level for the first data based on a predetermined value, and if the indication is present, determine the compression level for the first data based on a status of a queue of the programmable circuitry.

### BACKGROUND

Hardware accelerators are often used for compute-intensive file compression operations. Hardware accelerators can typically perform at least one level of compression. Users can select different levels of compression to be performed on files based on their preference of speed versus compression ratio.

### BRIEF DESCRIPTION OF THE DRAWINGS

FIG. 1 is a block diagram of an example environment in which example compression accelerator circuitry operates to compress data.

FIG. 2 is a block diagram of an example implementation of the compression accelerator circuitry of FIG. 1.

FIG. 3 is a flowchart representative of example machine readable instructions and/or example operations that may be executed, instantiated, and/or performed by example programmable circuitry to implement the compression accelerator circuitry of FIG. 2.

FIG. 4 is a flowchart representative of example machine readable instructions and/or example operations that may be executed, instantiated, and/or performed by example programmable circuitry to implement the compression accelerator circuitry of FIG. 2.

FIG. 5 is a block diagram of an example processing platform including programmable circuitry structured to execute, instantiate, and/or perform the example machine readable instructions and/or perform the example operations of FIGS. 3 and 4 to implement the compression accelerator circuitry of FIG. 2.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine readable instructions of FIGS. 3 and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

File compression is a compute-intensive task which benefits significantly from specialized hardware accelerators. Further, there is generally a tradeoff between performance (e.g., speed) and compression ratio when performing file compression operations. File compression software often provides multiple levels of compression for users to select between speed and different levels of compression.

Some compression software keeps the number of compression levels constant throughout development of the software while other compression software continues to add more levels as the software develops. Adding a relatively large number of compression levels and keeping older compression levels to preserve the behavior of earlier versions of the compression software is not a large burden. For example, maintaining support for earlier versions requires relatively more memory, however, no substantial changes to the compression software are needed.

Specialized hardware accelerators generally only support a fixed number of compression levels and keeping older compression levels to preserve the behavior of earlier versions introduces significant complexity. For example, hardware architecture between revisions changes over time and keeping older compression levels would require keeping older hardware architectures. Including (e.g., supporting) multiple hardware architectures requires an increase in size and complexity of the specialized hardware accelerators. As such, supporting multiple hardware architectures is not always possible or desired. However, users of the specialized hardware accelerators generally expect some level of consistency across revisions of the specialized hardware accelerators.

Further, users of file compression software or a specialized hardware accelerator do not always want to specify which level of compression or speed desired for compressing data. For example, some users want to input the data to be compressed to the file compression software or the specialized hardware accelerator and have it be compressed without further input. In such examples, the user trusts the file compression software or the specialized hardware accelerator to select the best options by itself. However, known file compression software and specialized hardware accelerators do not always select the best options for compression because they do not consider utilization of the hardware or software, compressibility of the data, or other factors which influence the speed and compression of the data.

Examples disclosed herein solve or at least reduce the issues described above. Examples disclosed herein provide an apparatus including machine readable instructions, and programmable circuitry to at least one of instantiate or execute the machine readable instructions to determine if a indication of compression mode selection corresponding to first data is present, if the indication is not present, select a compression level for the first data based on a predetermined value, and if the indication is present, determine the compression level for the first data based on a status of a queue of the programmable circuitry. Further, examples disclosed herein provide a non-transitory machine readable storage medium including instructions to cause programmable circuitry to at least receive first data to be compressed, determine a requested compression level of the first data, determine a total number of compression levels of the programmable circuitry, and determine an effective compression level of the first data based on the requested compression level and the total number of compression levels.

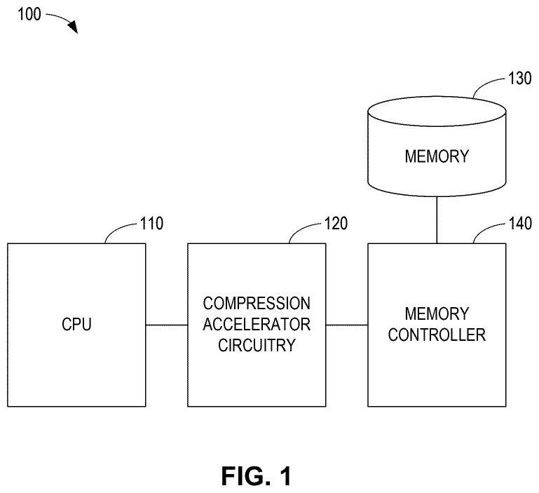

FIG. 1 is a block diagram of an example computer 100 in which an example compression accelerator circuitry 120 operates to compress data for storage in memory 130. The compression accelerator circuitry 120 is coupled with a central processing unit (CPU) 110 and a memory controller 140. The CPU 110 sends commands (e.g., instructions) to the compression accelerator circuitry 120 to compress data and store the data in the memory 130. For example, the CPU 110 sends instructions to the compression accelerator circuitry 120 to retrieve (e.g., obtain) first data from the memory 130 via the memory controller 140. The compression accelerator circuitry 120 then obtains and compresses the first data from the memory controller 140 before sending the first data to be stored in the memory 130 via the memory controller 140. In some examples, the CPU 110 sets flags (e.g., bits, indications, indicators, etc.) corresponding to the first data to the compression accelerator circuitry 120 to indicate a level of compression or speed to be used when compressing the first data. In some examples, the compression accelerator circuitry 120 receives performance (e.g., utilization) data from the CPU 120 regarding the computer 100.

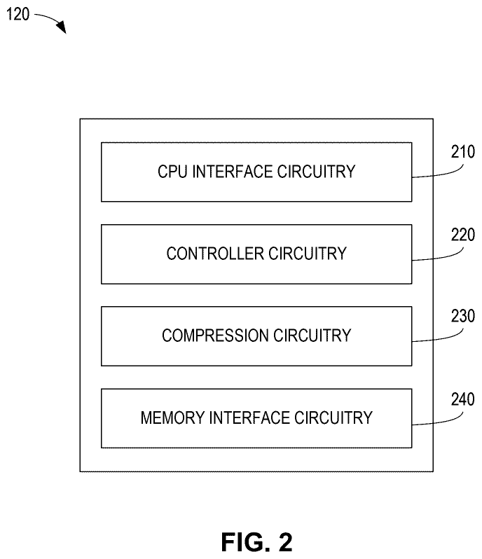

FIG. 2 is a block diagram of an example implementation of the compression accelerator circuitry 120 of FIG. 1 to compress data. The compression accelerator circuitry 120 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the compression accelerator circuitry 120 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The example compression accelerator circuitry 120 includes CPU interface circuitry 210, controller circuitry 220, compression circuitry 230, and memory interface circuitry 240.

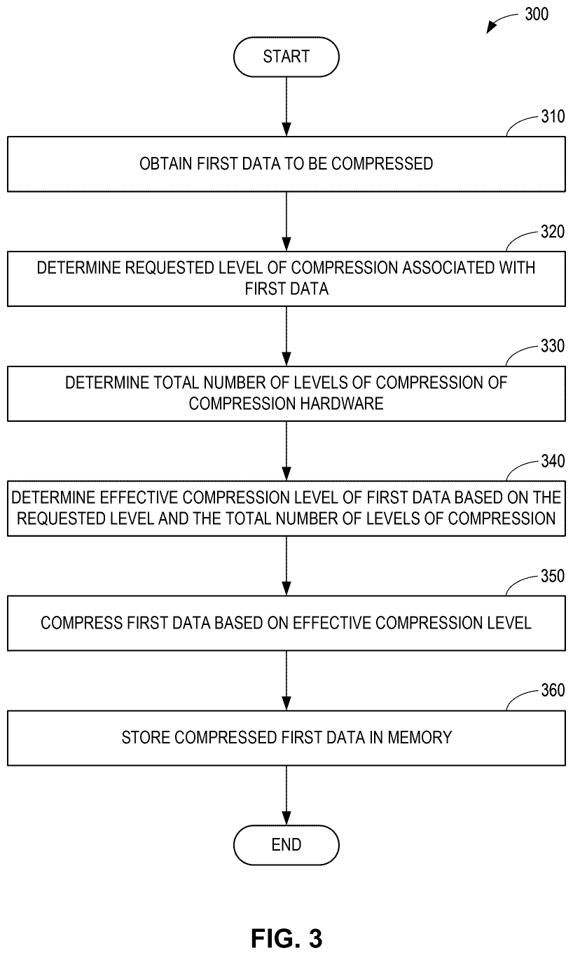

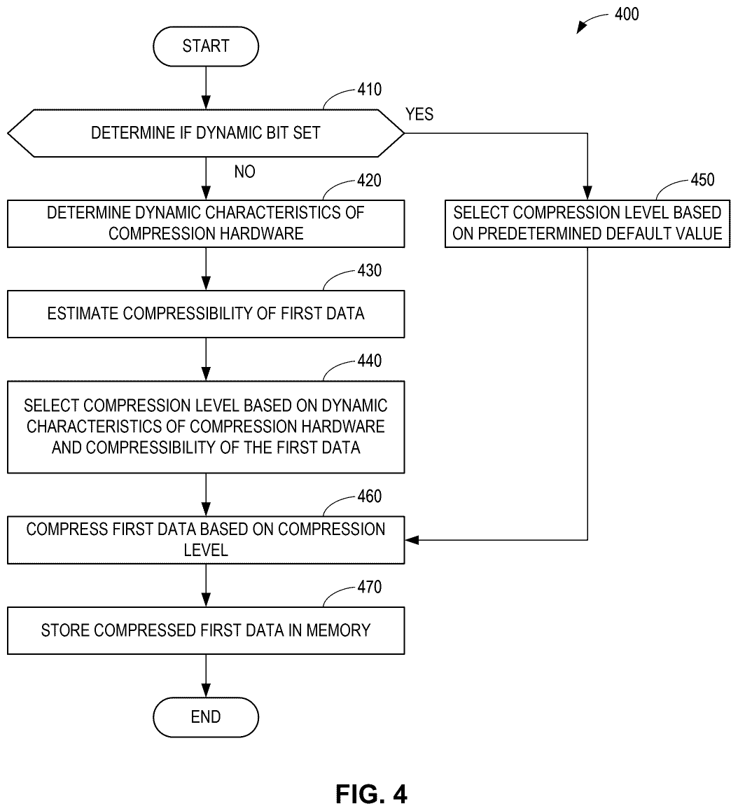

In some examples, the CPU interface circuitry 210 is instantiated by programmable circuitry executing CPU interface circuitry 210 instructions and/or configured to perform operations such as those represented by the flowchart(s) of FIGS. 3 and 4.

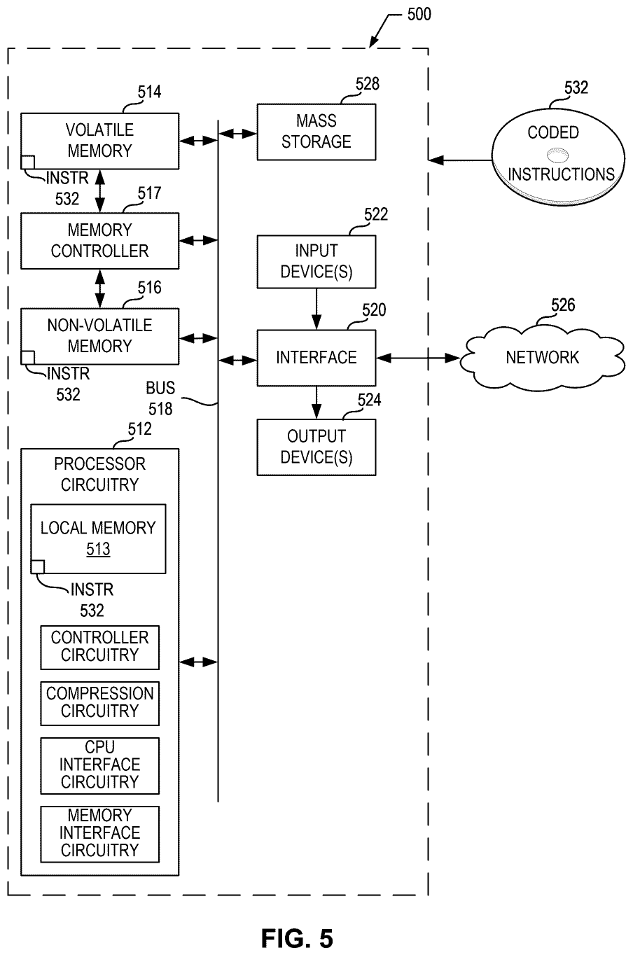

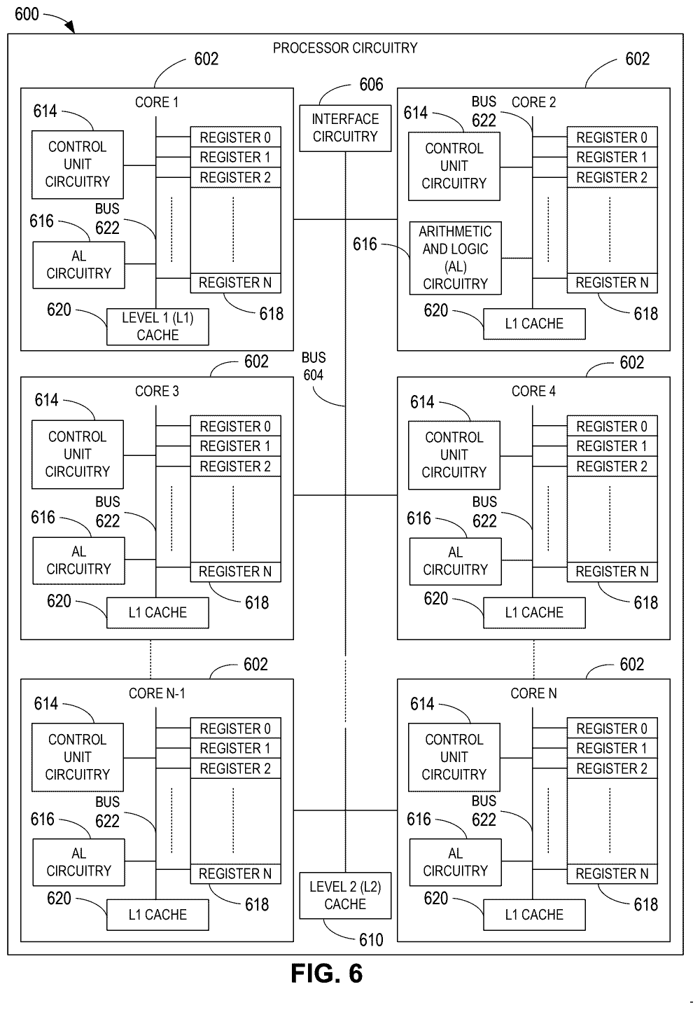

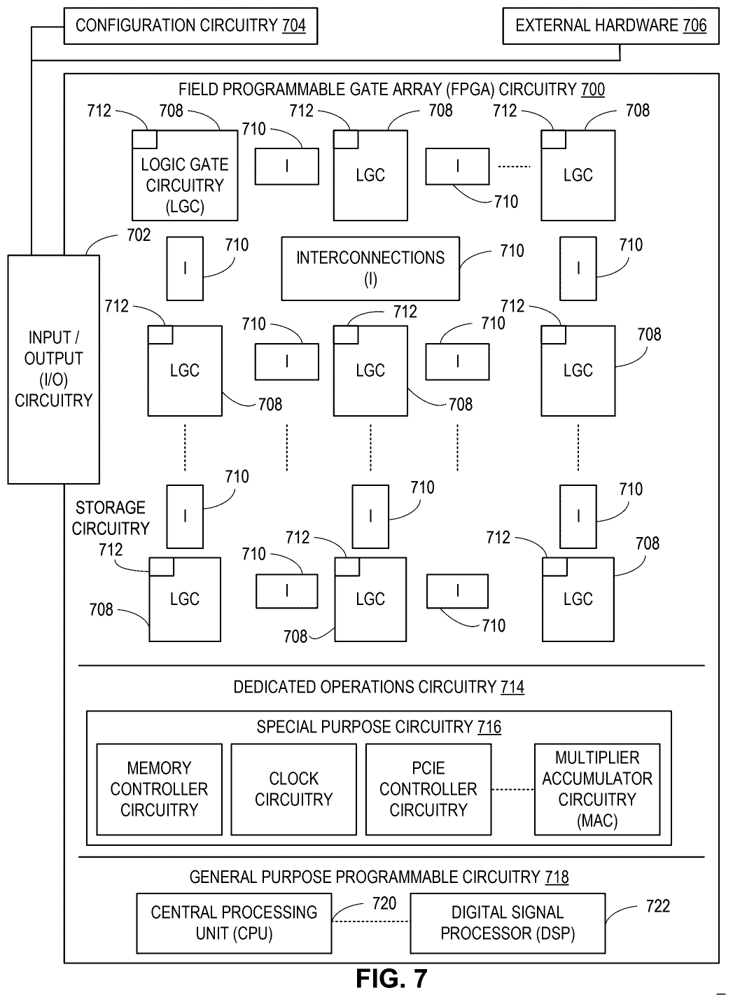

In some examples, the compression accelerator circuitry 120 includes means for interfacing with a CPU. For example, the means for interfacing with a CPU may be implemented by CPU interface circuitry 210. In some examples, the CPU interface circuitry 210 may be instantiated by programmable circuitry such as the example programmable circuitry 512 of FIG. 5. For instance, the CPU interface circuitry 210 may be instantiated by the example microprocessor 600 of FIG. 6 executing machine executable instructions such as those implemented by at least block 310 of FIG. 3. In some examples, CPU interface circuitry 210 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the CPU interface circuitry 210 may be instantiated by any other combination of hardware, software, and/or firmware. For example, the CPU interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the controller circuitry 220 is instantiated by programmable circuitry executing controller circuitry 220 instructions and/or configured to perform operations such as those represented by the flowchart(s) of FIGS. 3 and 4.

In some examples, the compression accelerator circuitry 120 includes means for controlling. For example, the means for controlling may be implemented by controller circuitry 220. In some examples, the controller circuitry 220 may be instantiated by programmable circuitry such as the example programmable circuitry 512 of FIG. 5. For instance, the controller circuitry 220 may be instantiated by the example microprocessor 600 of FIG. 6 executing machine executable instructions such as those implemented by at least blocks 320, 330, 340, 350, 410, 420, 430, 440, 450, and 480 of FIGS. 3 and 4. In some examples, the controller circuitry 220 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the controller circuitry 220 may be instantiated by any other combination of hardware, software, and/or firmware. For example, the controller circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the compression circuitry 230 is instantiated by programmable circuitry executing compression circuitry 230 instructions and/or configured to perform operations such as those represented by the flowchart(s) of FIGS. 3 and 4.

In some examples, the compression accelerator circuitry 120 includes means compressing data. For example, the means for compressing data may be implemented by compression circuitry 230. In some examples, the compression circuitry 230 may be instantiated by programmable circuitry such as the example programmable circuitry 512 of FIG. 5. For instance, the compression circuitry 230 may be instantiated by the example microprocessor 600 of FIG. 6 executing machine executable instructions such as those implemented by at least blocks 350 and 470 of FIGS. 3 and 4. In some examples, the compression circuitry 230 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the compression circuitry 230 may be instantiated by any other combination of hardware, software, and/or firmware. For example, the compression circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the memory interface circuitry 240 is instantiated by programmable circuitry executing memory interface circuitry 240 instructions and/or configured to perform operations such as those represented by the flowchart(s) of FIGS. 3 and 4.

In some examples, the compression accelerator circuitry 120 includes means for interfacing with a memory. For example, the means for interfacing with a memory may be implemented by memory interface circuitry 240. In some examples, the memory interface circuitry 240 may be instantiated by programmable circuitry such as the example programmable circuitry 512 of FIG. 5. For instance, the memory interface circuitry 240 may be instantiated by the example microprocessor 600 of FIG. 6 executing machine executable instructions such as those implemented by at least blocks 360 and 480 of FIGS. 3 and 4. In some examples, memory interface circuitry 240 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the memory interface circuitry 240 may be instantiated by any other combination of hardware, software, and/or firmware. For example, the memory interface circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the compression accelerator circuitry 120 of FIG. 1 is illustrated in FIG. 2, one or more of the elements, processes, and/or devices illustrated in FIG. 2 may be combined, divided, re-arranged, omitted, eliminated, and/or implemented in any other way. Further, the CPU interface circuitry 210, the controller circuitry 220, the compression circuitry 230, the memory interface circuitry 240, and/or, more generally, the example compression accelerator circuitry 120 of FIG. 2, may be implemented by hardware alone or by hardware in combination with software and/or firmware. Thus, for example, any of the CPU interface circuitry 210, the controller circuitry 220, the compression circuitry 230, the memory interface circuitry 240, and/or, more generally, the example compression accelerator circuitry 120, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example compression accelerator circuitry 120 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed by programmable circuitry to implement and/or instantiate the compression accelerator circuitry of FIG. 2 and/or representative of example operations which may be performed by programmable circuitry to implement and/or instantiate the compression accelerator circuitry of FIG. 2, are shown in FIGS. 3 and 4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3 and 4, many other methods of implementing the example compression accelerator circuitry 120 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to compress data where the programmable circuitry has a fixed number of compression levels. The example machine-readable instructions and/or the example operations 300 of FIG. 3 begin at block 310, at which the memory interface circuitry 240 obtains first data to be compressed. For example, the CPU 110 can instruct the compression accelerator circuitry 120 to compress first data which is then obtained (e.g., retrieved) by the memory interface circuitry 240 from the memory 130 via the memory controller 140. In some examples, the CPU 110 instructs the memory controller 140 to provide the first data to the compression accelerator 120. For example, the memory controller 140 can retrieve the first data from the memory 130 and provide it to the memory interface circuitry 240 for compression. Control then proceeds to block 320.

At block 320 the controller circuitry 220 determines a requested level of compression associated with the first data. For example, the first data can include a compression mode value (e.g., a four-bit value) which indicates a compression level (e.g., speed and/or compression ratio) and a compression long-match hint. In such examples, the controller circuitry 220 can determine the requested level of compression associated with the first data based on the compression mode value. Control then proceeds to block 330.

The compression long-match hint enables the compression circuitry 230 to find matches more efficiently. When compressing data, the goal is to generally find the longest possible data and replace it with a pointer which is much smaller. The compression long-match hint is calculated as part of a pre-processing step in which a quick search is performed so as to prevent the compression circuitry 230 from doing that search.

At block 330 the controller circuitry 220 determines a total number of levels of compression of the compression accelerator circuitry 120. For example, the compression accelerator circuitry 120 can include a plurality of levels of compression. In some examples, the compression accelerator circuitry 120 includes a fixed number of levels of compression (e.g., 1, 2, 3, etc.) defined by an architecture of the compression accelerator circuitry 120. Control then proceeds to block 340.

At block 340 the controller circuitry 220 determines an effective compression level of the first data based on the requested level and the total number of compression levels of the compression accelerator circuitry 120. In some examples, the requested compression level corresponds to one of a fixed number of previously determined compression levels. For example, the previously determined compression levels can correspond to a plurality (e.g., 1, 2, 3, etc.) of example compression accelerator circuits. In such examples, a user of the compression accelerator circuitry 120 may expect a similar level of performance across multiple example compression circuits including the compression accelerator circuitry 120.

For example, the requested level of compression can be one of seven previously determined compression levels. In the same example, the compression accelerator circuitry 120 can include four compression levels. In such an example, if the requested compression level corresponding to the first data was of the highest level (e.g., seven) the controller circuitry 220 can determine that the first data has the effective compression level of four which corresponds to the highest level of compression of the compression accelerator circuitry 120. In some examples, the number of previously determined compression levels can be greater than the number of levels of compression of the compression accelerator circuitry 120.

In some examples, the effective compression level is further based on minimizing a difference between the requested compression level and the total number of compression levels of the compression accelerator circuitry 120. In some examples, the effective compression level is further based on a linear mapping between the requested compression level and the total number of compression levels. For example, if the number of previously determined compression levels is eight, the compression accelerator circuitry 120 includes four compression levels, and the requested compression level of the first data is four, the effective compression level of the first data can be two. In still other examples, the effective compression level is further based on a non-linear mapping between the requested compression level and the total number of compression levels. For example, across a plurality of example compression accelerator circuits performance may differ and a non-linear mapping can be used to provide consistency across the predetermined levels of compression. After the effective compression level of the first data is determined by the controller circuitry 220 control proceeds to block 350.

At block 350 the compression circuitry 230 compresses the first data based on the effective compression level. For example, the compression circuitry 230 is instructed by the controller circuitry 220 to compress the first data at the effective compression level determined by the controller circuitry 220. Control then proceeds to block 360.

At block 360 the memory interface circuitry 240 stores the compressed first data in memory. For example, the controller circuitry 220 can instruct the memory interface circuitry 240 to store the compressed first data in the memory 130 via the memory controller 140.

FIG. 4 is a flowchart representative of example machine readable instructions and/or example operations 400 that may be executed, instantiated, and/or performed by programmable circuitry to determine a compression level for first data. The example machine-readable instructions and/or the example operations 400 of FIG. 3 begin at block 410, at which the controller circuitry 220 determines if a dynamic bit (e.g., a flag, an indication of compression mode selection, an indicator, etc.) corresponding to the first data is set (e.g., present). For example, the dynamic bit can indicate that a compression level corresponding to the first data is to be determined by the compression accelerator circuitry 120. If it is determined that the flag is not set (e.g., does not indicate that the compression level corresponding to the first data should be determined by the compression accelerator circuitry 120) control proceeds to block 450. Alternatively, if the flag is set control proceeds to block 420.

At block 450 the control circuitry 220 selects the compression level for the first data based on a predetermined (e.g., default) value. For example, the predetermined value can be configured by the user or a system administrator. Control then proceeds to block 470.

At block 420 the control circuitry 220 determines (e.g., obtains, receives, calculates, etc.) dynamic characteristics of the compression accelerator circuitry 120. In some examples, the control circuitry 220 can analyze a queue (e.g., a status of the queue) of the compression accelerator circuitry 120. For example, the compression accelerator circuitry 120 can be used by a plurality of users and the queue can consist of files to be compressed which were provided by the users. The controller circuitry 220 can determine a queue length of the queue based on a number of files in the queue. In some examples, the controller circuitry 220 can determine a queue utilization rate or a time to complete the queue based on the number of files in the queue, a size of the files in the queue, and a compressibility of the files in the queue. For example, certain files may be more difficult to compress, or a compression mode associated with the file may request a relatively high level of compression which takes a relatively long period of time. Control then proceeds to block 430.

At block 430 the controller circuitry 220 estimates compressibility of the first data. For example, the controller circuitry 220 can estimate (e.g., determine) the compressibility of the first data based on a frequency analysis of the first data. In some examples, the controller circuitry 220 can perform pattern matching to determine the compressibility of the first data. In yet other examples, the controller circuitry 220 can determine the compressibility of the first data based on the compression long-match hint. Control then proceeds to block 440.

At block 440 the controller circuitry 220 selects a compression level for the first data based on the dynamic characteristics of the compression accelerator circuitry 120 and the compressibility of the first data. For example, the controller circuitry 220 can select from a plurality of compression levels based on the dynamic characteristics of the compression accelerator hardware 120 and the compressibility of the first data. In some examples, the controller circuitry 220 can determine that the queue length, queue utilization rate, or the time to complete the queue are above (e.g., greater than) a first threshold indicating that a workload of the compression accelerator circuitry 120 is relatively high. In such an example, the controller circuitry 220 can also determine that the compressibility of the first data is relatively low. In the same example, the controller circuitry 220 can select a first compression level for the first data where the first compression level corresponds to a relatively low level of compression. In some examples, the controller circuitry 220 can determine that the queue length, queue utilization rate, or the time to complete the queue are below (e.g., less than) the first threshold indicating that the workload of the compression accelerator circuitry 120 is relatively low. In such an example, the controller circuitry 220 can also determine that the compressibility of the first data is relatively high. In the same example, the controller circuitry 220 can select a second compression level for the first data where the second compression level corresponds to a relatively high level of compression.

This is to say that the controller circuitry 220 can dynamically select (e.g., determine, calculate, etc.) the compression level for the first data based on a variety of parameters including the dynamic characteristics of the compression accelerator circuitry 120, the compressibility of the first data, etc. The controller circuitry 220 can further be configured to select the compression level for the first data based on input from a system admin associated with the compression accelerator circuitry 120. For example, the system admin can configure the controller circuitry 220 so that when the workload of the compression accelerator circuitry 120 is relatively low the controller circuitry 220 will select relatively higher levels of compression for the first data. This is advantageous because the compression accelerator circuitry 120 can dynamically adjust compression levels so that it is outputting a maximum amount of work. This means that when the workload is relatively low, the compression accelerator circuitry 120 will output files that are relatively higher compressed than when the workload is relatively high. Control then proceeds to block 450.

At block 450 the compressor circuitry 230 compresses the first data based on the compression level selected at block 440. Control then proceeds to block 460.

At block 460 the memory interface circuitry 240 stores the compressed first data in memory. For example, the controller circuitry 220 can instruct the memory interface circuitry 240 to store the compressed first data in the memory 130 via the memory controller 140.

FIG. 5 is a block diagram of an example programmable circuitry platform 500 structured to execute and/or instantiate the example machine-readable instructions and/or the example operations of FIGS. 3 and 4 to implement the compression accelerator circuitry 120 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices. In this example, the programmable circuitry 512 implements the CPU interface circuitry 210, the controller circuitry 220, the compression circuitry 230, and the memory interface circuitry 240

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIGS. 3 and 4, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIGS. 3 and 4 to effectively instantiate the circuitry of FIG. 2 as logic circuits to perform operations corresponding to those machine readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3 and 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart(s) of FIGS. 3 and 4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3 and 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3 and 4. As such, the FPGA circuitry 700 may be configured and/or structured to effectively instantiate some or all of the operations/functions corresponding to the machine readable instructions of the flowchart(s) of FIGS. 3 and 4 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIGS. 3 and 4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIGS. 3 and 4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIGS. 3 and 4 to perform first operation(s)/function(s), the FPGA circuitry 700 of FIG. 7 may be configured and/or structured to perform second operation(s)/function(s) corresponding to a second portion of the machine readable instructions represented by the flowcharts of FIGS. 3 and 4, and/or an ASIC may be configured and/or structured to perform third operation(s)/function(s) corresponding to a third portion of the machine readable instructions represented by the flowcharts of FIGS. 3 and 4.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

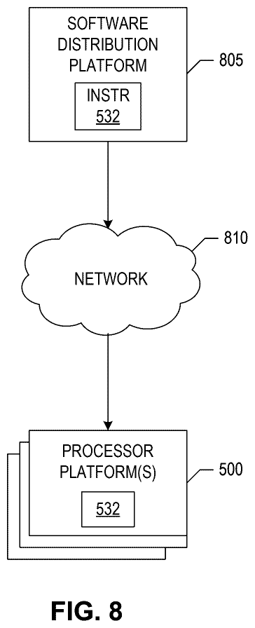

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3 and 4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIGS. 3 and 4, may be downloaded to the example programmable circuitry platform 500, which is to execute the machine readable instructions 532 to implement the compression accelerator circuitry. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture for compression modes in hardware accelerators are disclosed herein. Further examples and combinations thereof include the following:
Example 1 includes an apparatus comprising machine readable instructions, and programmable circuitry to at least one of instantiate or execute the machine readable instructions to determine if an indication of compression mode selection corresponding to first data is present, if the indication is not present, select a compression level for the first data based on a predetermined value, and if the indication is present, determine the compression level for the first data based on a status of a queue of the programmable circuitry.
Example 2 includes the apparatus of example 1, wherein if a queue length of the queue is less than a first threshold, the programmable circuitry determines the compression level is a first compression level.
Example 3 includes the apparatus of example 2, wherein if the queue length of the queue is greater than the first threshold, the programmable circuitry determines the compression level is a second compression level.
Example 4 includes the apparatus of any one or more of examples 1-3, wherein determining the compression level is further based on an estimated compressibility of the first data.
Example 5 includes the apparatus of example 4, wherein the estimated compressibility of the first data is determined based on a compression long-match hint.
Example 6 includes the apparatus of any one or more of examples 1-5, wherein determining the compression level for the first data is further based on utilization of the programmable circuitry.
Example 7 includes the apparatus of any one or more of examples 1-6, further including compressing the first data based on the compression level for the first data.
Example 8 includes a non-transitory machine readable storage medium comprising instructions to cause programmable circuitry to at least receive first data to be compressed, determine a requested compression level of the first data, determine a total number of compression levels of the programmable circuitry, and determine an effective compression level of the first data based on the requested compression level and the total number of compression levels.
Example 9 includes the non-transitory machine readable storage medium of example 8, wherein the requested compression level corresponds to one of a fixed number of previously determined compression levels.
Example 10 includes the non-transitory machine readable storage medium of example 9, wherein the total number of compression levels of the programmable circuitry is less than the fixed number of previously determined compression levels.
Example 11 includes the apparatus of any one or more of examples 8-10, wherein determining the effective compression level is further based on a linear mapping between the requested compression level and the total number of compression levels.
Example 12 includes the apparatus of any one or more of examples 8-11, wherein determining the effective compression level is further based on a non-linear mapping between the requested compression level and the total number of compression levels.
Example 13 includes the apparatus of any one or more of examples 8-12, wherein determining the effective compression level is further based on minimizing a difference between the requested compression level and the total number of compression levels.
Example 14 includes a non-transitory machine readable storage medium comprising instructions to cause programmable circuitry to at least determine if an indication of compression mode selection corresponding to first data is present, if the indication is not present, select a compression level for the first data based on a predetermined value, and if the indication is present, determine the compression level for the first data based on a queue of the programmable circuitry.
Example 15 includes the non-transitory machine readable storage medium of example 14, wherein if a queue length of the queue is less than a first threshold the instructions cause the programmable circuitry to determine the compression level is a first compression level.
Example 16 includes the non-transitory machine readable storage medium of example 15, wherein if a queue length of the queue is less than a first threshold the instructions cause the programmable circuitry to determine the compression level is a first compression level.
Example 17 includes the apparatus of any one or more of examples 15-16, wherein determining the compression level is further based on an estimated compressibility of the first data.
Example 18 includes the non-transitory machine readable storage medium of example 17, wherein the estimated compressibility is determined based on a compression long-match hint.
Example 19 includes the apparatus of any one or more of examples 14-18, wherein determining the compression level is further based on utilization of the programmable circuitry.
Example 20 includes the apparatus of any one or more of examples 14-19, wherein the instructions cause the programmable circuitry to compress the first data based on the compression level.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
machine readable instructions; and
programmable circuitry to at least one of instantiate or execute the machine readable instructions to:
determine if an indication of compression mode selection corresponding to first data is present;
if the indication is not present, select a compression level for the first data based on a predetermined value; and
if the indication is present, determine the compression level for the first data based on a status of a queue of the programmable circuitry.

2. The apparatus of claim 1, wherein if a queue length of the queue is less than a first threshold, the programmable circuitry determines the compression level is a first compression level.

3. The apparatus of claim 2, wherein if the queue length of the queue is greater than the first threshold, the programmable circuitry determines the compression level is a second compression level.

4. The apparatus of claim 1, wherein determining the compression level is further based on an estimated compressibility of the first data.

5. The apparatus of claim 4, wherein the estimated compressibility of the first data is determined based on a compression long-match hint.

6. The apparatus of claim 1, wherein determining the compression level for the first data is further based on utilization of the programmable circuitry.

7. The apparatus of claim 1, further including compressing the first data based on the compression level for the first data.

8. A non-transitory machine readable storage medium comprising instructions to cause programmable circuitry to at least:
receive first data to be compressed;
determine a requested compression level of the first data;
determine a total number of compression levels of the programmable circuitry; and
determine an effective compression level of the first data based on the requested compression level and the total number of compression levels.

9. The non-transitory machine readable storage medium of claim 8, wherein the requested compression level corresponds to one of a fixed number of previously determined compression levels.

10. The non-transitory machine readable storage medium of claim 9, wherein the total number of compression levels of the programmable circuitry is less than the fixed number of previously determined compression levels.

11. The non-transitory machine readable storage medium of claim 8, wherein determining the effective compression level is further based on a linear mapping between the requested compression level and the total number of compression levels.

12. The non-transitory machine readable storage medium of claim 8, wherein determining the effective compression level is further based on a non-linear mapping between the requested compression level and the total number of compression levels.

13. The non-transitory machine readable storage medium of claim 8, wherein determining the effective compression level is further based on minimizing a difference between the requested compression level and the total number of compression levels.

14. A non-transitory machine readable storage medium comprising instructions to cause programmable circuitry to at least:
determine if an indication of compression mode selection corresponding to first data is present;
if the indication is not present, select a compression level for the first data based on a predetermined value; and
if the indication is present, determine the compression level for the first data based on a queue of the programmable circuitry.

15. The non-transitory machine readable storage medium of claim 14, wherein if a queue length of the queue is less than a first threshold the instructions cause the programmable circuitry to determine the compression level is a first compression level.

16. The non-transitory machine readable storage medium of claim 15, wherein if a queue length of the queue is less than a first threshold the instructions cause the programmable circuitry to determine the compression level is a first compression level.

17. The non-transitory machine readable storage medium of claim 15, wherein determining the compression level is further based on an estimated compressibility of the first data.

18. The non-transitory machine readable storage medium of claim 17, wherein the estimated compressibility is determined based on a compression long-match hint.

19. The non-transitory machine readable storage medium of claim 14, wherein determining the compression level is further based on utilization of the programmable circuitry.

20. The non-transitory machine readable storage medium of claim 14, wherein the instructions cause the programmable circuitry to compress the first data based on the compression level.
